(19) United States
(12) Patent Application Publication
(10) Pub. No.: US 2020/0003365 A1
(43) Pub. Date: Jan. 2, 2020

(54) HYDROGEN GAS COMPRESSING SYSTEM AND HYDROGEN GAS COMPRESSION METHOD

(71) Applicant: TOYOTA JIDOSHA KABUSHIKI KAISHA, Toyota-shi (JP)

(72) Inventors: Toshiyuki KONDO, Chiryu-shi (JP); Masanosuke SUFU, Toyota-shi (JP); Kentaro OTOKUBO, Nagoya-shi (JP); Shinji SASSA, Ama-shi (JP); Hiroki ANDO, Toyota-shi (JP)

(21) Appl. No.: 16/444,135

(22) Filed: Jun. 18, 2019

(30) Foreign Application Priority Data
Jun. 28, 2018 (JP) 2018-122676

(51) Int. Cl. F17C 5/06; F04B 41/02

(52) U.S. Cl. CPC F17C 5/06; F17C 2225/036; F17C 2221/012; F04B 41/02

(57) ABSTRACT

A hydrogen gas compression system comprises a hydrogen storage chamber placed at a predetermined water depth in water to communicate with surrounding water; a hydrogen container filled with hydrogen gas by a lower pressure than a hydraulic pressure at the predetermined water depth; a transporting portion configured to guide the hydrogen container that is filled with the hydrogen gas, from above the predetermined water depth to the hydrogen storage chamber; a gas release portion configured to cause the hydrogen gas to be released from the hydrogen container transported to the hydrogen storage chamber and to be stored in the hydrogen storage chamber; a hydrogen recovery device placed above the predetermined depth; and a tube arranged to connect inside of the hydrogen storage chamber with the hydrogen recovery device.

### CROSS REFERENCE TO RELATED APPLICATIONS

The present application claims priority from Japanese patent application 2018-122676 filed on Jun. 28, 2018, the entirety of the content of which is hereby incorporated by reference into this application.

### BACKGROUND

### Field

The present disclosure relates to compression and storage of hydrogen gas.

### Related Art

There has been an increasing demand for hydrogen as a fuel used for power generation of fuel cells or as an industrial material. Hydrogen gas produced in a hydrogen production plant or the like may be compressed in the hydrogen production plant or at a hydrogen gas station before being stored in a container and may be supplied via a dispenser to a fuel consuming device such as a fuel cell vehicle. JP 2017-131862A discloses a configuration of causing hydrogen gas produced by a gas production device to be compressed by a compressor, to be stored temporarily in a pressure accumulator and to be filled into a vehicle via a dispenser.

For the purpose of storage of a large amount of hydrogen gas, the hydrogen gas is generally compressed to a high-pressure gas of, for example, 70 MPa (megapascals) as described in JP 2017-131862A. This configuration requires a compressor and has a problem of a large compression cost for the hydrogen gas supply. Additionally, there is a need for a container that withstands the high pressure, in terms of storing the compressed high-pressure hydrogen gas. This has another problem of a large storage cost. There is accordingly a demand for a technique that reduces the cost required for compression and storage of hydrogen gas.

### SUMMARY

According to one aspect of the present disclosure, there is provided a hydrogen gas compression system. This hydrogen gas compression system comprises a hydrogen storage chamber placed at a predetermined water depth in water to communicate with surrounding water; a hydrogen container filled with hydrogen gas by a lower pressure than a hydraulic pressure at the predetermined water depth; a transporting portion configured to guide the hydrogen container that is filled with the hydrogen gas, from above the predetermined water depth to the hydrogen storage chamber; a gas release portion configured to cause the hydrogen gas to be released from the hydrogen container transported to the hydrogen storage chamber and to be stored in the hydrogen storage chamber; a hydrogen recovery device placed above the predetermined depth; and a tube arranged to connect inside of the hydrogen storage chamber with the hydrogen recovery device.

### BRIEF DESCRIPTION OF THE DRAWINGS

FIG. 1 is a diagram illustrating the schematic configuration of a hydrogen gas compression system according to one embodiment of the present disclosure;

FIG. 2 is an appearance diagram illustrating the configuration of a hydrogen container;

FIG. 3 is a process chart showing a procedure of a hydrogen gas compression process; and

FIG. 4 is a diagram illustrating the schematic configuration of a hydrogen gas compression system according to a second embodiment.

### DETAILED DESCRIPTION

### A. First Embodiment

### A1. System Configuration

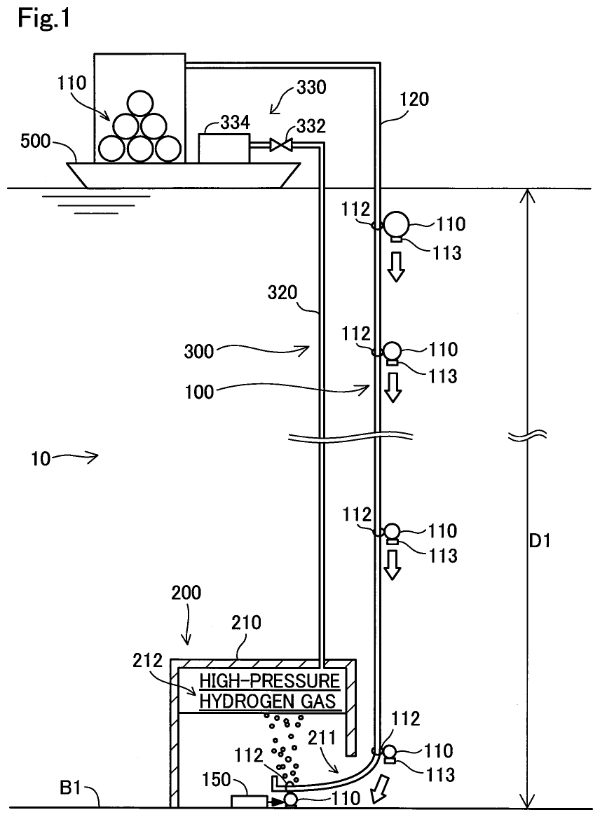

FIG. 1 is a diagram illustrating the schematic configuration of a hydrogen gas compression system 10 according to one embodiment of the present disclosure. The hydrogen gas compression system 10 uses the hydraulic pressure in the sea to compress hydrogen gas and stores the compressed hydrogen gas. The hydrogen gas compression system 10 includes a transporting portion 100, a gas release portion 150, a storage portion 200 and a recovery portion 300.

The transporting portion 100 is configured to guide a hydrogen container 110 that is filled with hydrogen gas, to a hydrogen storage chamber 210 that is provided in the storage portion 200.

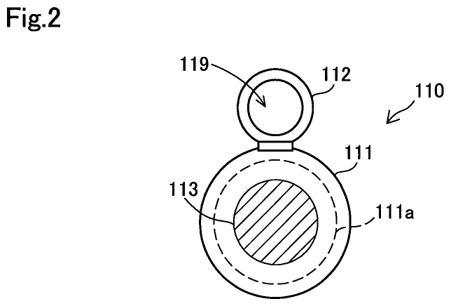

FIG. 2 is an appearance diagram illustrating the configuration of the hydrogen container 110. The hydrogen container 110 includes a main body portion 111, a mounting portion 112 and a weight portion 113. The main body portion 111 has an approximately spherical appearance shape and has a hydrogen gas containing portion 111a formed inside thereof. According to the embodiment, the main body portion 111 is made of aluminum. The main body portion 111 is designed to have such a thickness that the main body portion 111 is deformable by a hydraulic pressure at a water depth D1 shown in FIG. 1 or more specifically by a hydraulic pressure of approximately lower than 70.9 MPa but that the main body portion 111 is not cracked by the hydraulic pressure of approximately 70.9 MPa. The main body portion 111 has a gas filler port (not shown). Hydrogen gas is filled into the hydrogen gas containing portion 111a via this gas filler port. The gas fill port is sealed with a cover (not shown) after filling. The mounting portion 112 has a ring-shaped appearance and is joined with an outer surface of the main body portion 111. The mounting portion 112 is made of an alloy containing nickel and titanium. A guide support 120 described later is inserted into an opening 119 provided in the middle of the mounting portion 112. After the hydrogen container 110 is mounted to the guide support 120 by inserting the guide support 120 into the opening 119 as shown in FIG. 1, the hydrogen container 110 is thrown to the sea surface from a ship 500 and is then guided by the guide support 120 to sink toward a sea bottom B1 as described in detail later. The weight portion 113 shown in FIG. 2 is joined with part of the outer surface of the main body portion 111. The weight portion 113 serves as a weight such that the hydrogen container 110 sinks in the seawater in the state that the hydrogen gas containing portion 111a is filled with hydrogen. The weight portion 113 is made of, for example, an alloy containing nickel and titanium or a metal such as steel or lead. According to a modification, the mounting portion 112 may serve as a weight by adjusting the size and the weight of the mounting portion 112, and the weight portion 113 may be omitted.

As shown in FIG. 1, the transporting portion 100 is provided with the guide support 120. The guide support 120 is a rod-like structure having a circular section. The guide support 120 has one end that is mounted to the ship 500 and the other end that is placed in the vicinity of the sea bottom B1 to be located inside of the hydrogen storage chamber 210 provided in the sea bottom B1. According to the embodiment, a water depth D1 to the sea bottom B1 is approximately 7000 m (meters). According to the embodiment, the guide support 120 is made of an alloy containing nickel and titanium and has a strength that withstands the hydraulic pressure at the sea bottom B1. The guide support 120 may be formed by joining a large number of rod-like members of a predetermined length. The guide support 120 serves as a guide to guide the hydrogen container 110 to the hydrogen storage chamber 210. According to the embodiment, the guide support 120 is arranged approximately along a vertical direction to the vicinity of the sea bottom B1 and is bent such as to gradually approach the hydrogen storage chamber 210 toward the sea bottom B1.

The gas release portion 150 is placed on the sea bottom B1 and is configured to break the hydrogen container 110 transported to the vicinity of the sea bottom B1 and to cause hydrogen gas to be released from the hydrogen gas containing portion 111a to outside of the hydrogen container 110. For example, the gas release portion 150 may be comprised of a needle-like member made of an alloy containing nickel and titanium and an actuator configured to stick the needle-like member into the hydrogen container 110. In another example, the gas release portion 150 may be comprised of a hammer member and an actuator configured to hit the hammer member against the hydrogen container 110.

The storage portion 200 is fixed to the sea bottom B1 such as to surround the gas release portion 150 and is configured to store hydrogen gas released out of the hydrogen container 110. The storage portion 200 includes the hydrogen storage chamber 210 configured to store hydrogen gas therein. A space serving as a hydrogen gas storage portion 212 is formed inside of the hydrogen storage chamber 210. An inlet port 211 is formed in the hydrogen storage chamber 210. Inside of the hydrogen gas storage portion 212 is arranged to communicate with the surrounding seawater via the inlet port 211. Accordingly, there is no pressure difference between the internal pressure and the external pressure of the hydrogen storage chamber 210. The hydrogen storage chamber 210 itself is not required to have such a durability that withstands the pressure of approximately 70.9 MPa that is the hydraulic pressure at the water depth D1. According to the embodiment, the hydrogen storage chamber 210 is made of a resin having excellent corrosion resistance. A leading end portion of the guide support 120 is inserted from the inlet port 211 into the hydrogen gas storage portion 212. The hydrogen container 110 that is guided by the guide support 120 to sink accordingly enters from the inlet port 211 into the hydrogen gas storage portion 212.

The recovery portion 300 is configured to recover hydrogen gas stored in the hydrogen storage chamber 210. The recovery portion 300 includes a tube 320 and a hydrogen recovery device 330. The tube 320 has one end that is connected with a ceiling part of the hydrogen storage chamber 210 and the other end that is connected with the hydrogen recovery device 330. The tube 320 is arranged to connect the hydrogen gas storage portion 212 with the hydrogen recovery device 330 and causes the hydrogen gas stored in the hydrogen gas storage portion 212 to be led to the hydrogen recovery device 330. According to the embodiment, the tube 320 is designed to withstand a pressure difference between the internal pressure and the external pressure of the tube 320. More specifically, the internal pressure of the tube 320 is equal to the pressure of hydrogen gas in the hydrogen storage chamber 210 and is approximately equal to 70.9 MPa. The external pressure of the tube 320, on the other hand, reaches a minimum that is approximately 0.1 MPa at the water surface and reaches a maximum that is approximately 70.9 MPa in a location where the hydrogen storage chamber 210 is placed. The tube 320 is accordingly designed to withstand a maximum pressure difference (70.8 MPa) between 70.9 MPa and 0.1 MPa. According to the embodiment, the tube 320 is made of an alloy containing nickel and titanium. The tube 320 may be formed by, for example, joining a plurality of tube parts.

The hydrogen recovery device 330 is loaded on the ship 500 and is configured to recover hydrogen gas fed through the tube 320. The hydrogen recovery device 330 includes a shutoff valve 332 and a hydrogen processor 334. The shutoff valve 332 is a solenoid valve configured to open and close the tube 320 in response to a control signal from a controller (not shown). The hydrogen processor 334 is configured to process the hydrogen gas fed from the hydrogen storage chamber 210 through the tube 320. This process includes, for example, a process of inspecting hydrogen gas or a process of filling a hydrogen gas tank (not shown) with hydrogen gas.

### A2. Hydrogen Gas Compression Process

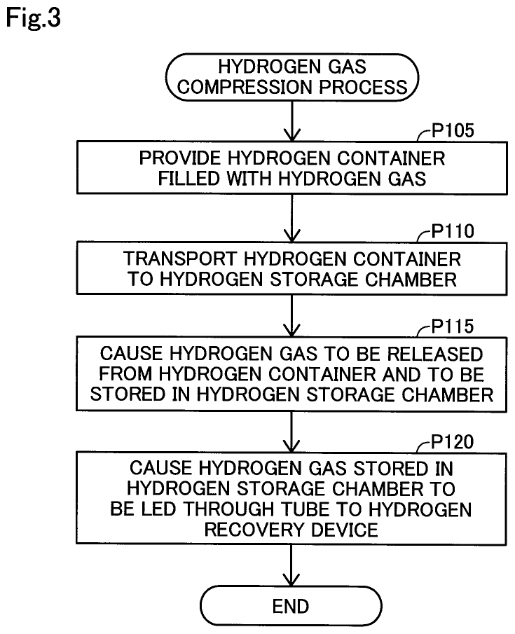

FIG. 3 is a process chart showing a procedure of a hydrogen gas compression process. This hydrogen gas compression process is performed to generate high-pressure hydrogen gas of approximately 70.9 MPa.

The hydrogen gas compression process first provides the hydrogen container 110 filled with hydrogen gas (process P105). According to the embodiment, hydrogen gas is generated and is filled into the hydrogen container 110 in a hydrogen production plant (not shown) on the land. According to the embodiment, the hydrogen gas is filled in a non-compressed state into the hydrogen container 110. According to a modification, the hydrogen gas may be compressed to a lower pressure than 70.9 MPa that is a target pressure in the hydrogen gas compression process before being filled into the hydrogen container 110. A large number of hydrogen containers 110 filled with hydrogen gas are loaded on the ship 500 and are transported to the location where the hydrogen storage chamber 210 is placed.

The hydrogen gas compression process subsequently transports the hydrogen container 110 to the hydrogen storage chamber 210 (process P110). The guide support 120 is made to pass through the opening 119 of the mounting portion 112 of the hydrogen container 110, and the hydrogen container 110 is thrown into water. The gravity of the hydrogen container 110 is higher than the buoyancy, so that the hydrogen container 110 is guided by the guide support 120 to sink toward the sea bottom B1. The hydraulic pressure increases while the hydrogen container 110 sinks down, so that the hydrogen container 110 is deformed to be dented inward. As schematically shown in FIG. 1, the hydrogen container 110 is thus gradually contracted while sinking down. As a result, the hydrogen gas filled in the hydrogen gas containing portion 111a is compressed. The hydrogen container 110 enters from the inlet port 211 to inside of the hydrogen gas storage portion 212 in the vicinity of the sea bottom B1.

As shown in FIG. 3, the hydrogen gas compression process causes the hydrogen gas to be released from the hydrogen container 110 by the gas release portion 150 and to be stored into the hydrogen storage chamber 210 (process P115). The hydrogen container 110 entering the hydrogen gas storage portion 212 is broken by the gas release portion 150. This causes the hydrogen gas filled in the hydrogen container 110 to be released into the hydrogen gas storage portion 212. The hydrogen gas filled in the hydrogen gas containing portion 111a has been compressed by the hydraulic pressure to reach the pressure of approximately 70.9 MPa at process P110 described above. The high-pressure hydrogen gas released into the hydrogen gas storage portion 212 is collected in a ceiling part of the hydrogen gas storage portion 212 to be stored as shown in FIG. 1.

As shown in FIG. 3, the hydrogen gas compression process then causes the hydrogen gas stored in the hydrogen storage chamber 210 to be led to the hydrogen recovery device 330 through the tube 320 (process P120). Changing the shutoff valve 332 from the valve-closing state to the valve-opening state causes the high-pressure hydrogen gas stored in the hydrogen gas storage portion 212 to be fed to the hydrogen processor 334 through the tube 320. The hydrogen gas fed to the hydrogen processor 334 is subjected to inspection or a process of filling a hydrogen gas tank in the hydrogen processor 334.

In the hydrogen gas compression system 10 of the first embodiment described above, the hydrogen container 110 filled with hydrogen gas at the lower pressure than the hydraulic pressure at the water depth D1 is transported to the hydrogen storage chamber 210. The hydrogen container 110 is compressed by the hydraulic pressure during the transportation, so that the hydrogen gas filled in the hydrogen container 110 is compressed. The hydrogen storage chamber 210 communicates with the surrounding water, so that the compressed hydrogen gas released from the hydrogen container 110 by the gas release portion 150 is stored in the compressed state in the hydrogen storage chamber 210. This configuration does not require a large-scale equipment that withstands the pressure of hydrogen gas and thereby reduces the storage cost of hydrogen gas. As described above, the hydrogen gas compression system 10 of the embodiment does not require a compressor or a storage equipment that withstands the high pressure for compression and storage of hydrogen gas and thereby reduces the cost required for compression and storage of hydrogen gas.

### B. Second Embodiment

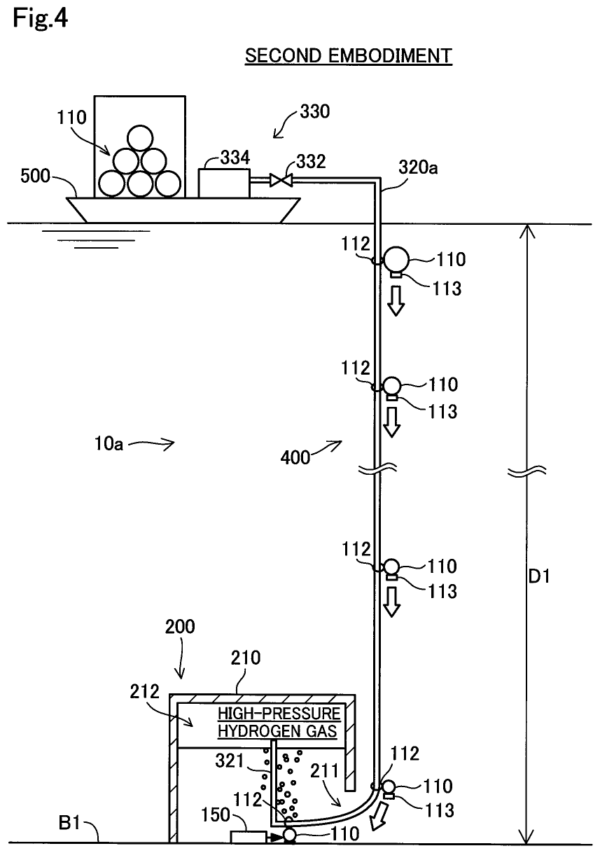

FIG. 4 is a diagram illustrating the schematic configuration of a hydrogen gas compression system 10a according to a second embodiment. The hydrogen gas compression system 10a of the second embodiment differs from the hydrogen gas compression system 10 of the first embodiment shown in FIG. 1 by that a transporting recovery portion 400 is provided instead of the transporting portion 100 and the recovery portion 300. Otherwise the configuration of the hydrogen gas compression system 10a of the second embodiment is similar to the configuration of the hydrogen gas compression system 10 of the first embodiment. Like components are expressed by like reference signs, and their detailed description is omitted.

The transporting recovery portion 400 is a functional portion having the combined functions of the transporting portion 100 and the recovery portion 300 of the first embodiment. More specifically, the transporting recovery portion 400 is configured to guide the hydrogen container 110 that is filled with hydrogen gas, to the hydrogen storage chamber 210 and to recover the hydrogen gas stored in the hydrogen storage chamber 210. The transporting recovery portion 400 includes a tube 320a, in addition to the hydrogen recovery device 330 described above.

The tube 320a is made of an alloy containing nickel and titanium, like the tube 320 of the first embodiment. The tube 320a has one end that is connected with the hydrogen recovery device 330. The tube 320a has the other end portion 321 that is extended vertically upward from the vicinity of the sea bottom B1. An opening at the end of the other end portion 321 is located in the vicinity of a ceiling of the hydrogen gas storage portion 212.

Like the first embodiment, as shown in FIG. 4, the hydrogen container 110 that is guided by the tube 320a to sink toward the sea bottom B1 is transferred to the hydrogen storage chamber 210 while being compressed by the hydraulic pressure. The hydrogen container 110 entering from the inlet port 211 into the hydrogen storage chamber 210 is broken by the gas release portion 150. This causes the hydrogen gas filled in the hydrogen gas containing portion 111a to be released into the hydrogen gas storage portion 212. The high-pressure hydrogen gas stored in the hydrogen gas storage portion 212 is led from the opening at the end of the other end portion 321 of the tube 320a through inside of the tube 320a to the hydrogen recovery device 330.

The hydrogen gas compression system 10a of the second embodiment described above has similar advantageous effects to those of the hydrogen gas compression system 10 of the first embodiment. Additionally, the hydrogen gas compression system 10a causes the hydrogen container 110 to be guided by the tube 320a and sunk. This configuration reduces the manufacturing cost of the hydrogen gas compression system 10a, compared with a configuration that is provided with a separate member to guide the hydrogen container 110 in a sinking direction.

### C. Other Embodiments

### C1. Another Embodiment 1

In the respective embodiments, the main body portion 111 of the hydrogen container 110 is made of aluminum. The material of the main body portion 111 is, however, not limited to aluminum but may be any other metal. The main body portion 111 may be made of a resin with a view to improving the corrosion resistance. In this case, the main body portion 111 may be configured to be deformed in a lower hydraulic pressure environment than approximately 70.9 MPa and to have such a strength that does not cause cracks even in this hydraulic pressure environment. This configuration has similar advantageous effects to those of the respective embodiments described above. For example, a resin liner used for a fuel tank for storage of hydrogen gas may be employed as the main body portion 111 of the hydrogen container 110.

### C2. Another Embodiment 2

The transporting portion 100 is provided with the guide support 120 according to the first embodiment. The present disclosure is, however, not limited to this configuration. In an area with little current of the sea, one available configuration may omit the guide support 120 and may cause the hydrogen container 110 thrown into the sea to sink by its own weight. Another available configuration may provide the guide support 120 with, for example, a power-driven lift and may use this lift to guide the hydrogen container 110 to the hydrogen storage chamber 210. In general, a transporting portion employing any arbitrary configuration to guide the hydrogen container 110 that is filled with hydrogen gas, to the hydrogen storage chamber 210 may be used as the transporting portion of the present disclosure.

### C3. Another Embodiment 3

In the respective embodiments, the hydrogen storage chamber 210 is placed on the sea bottom at the water depth of 7000 m. The hydrogen storage chamber 210 may, however, not be placed on the sea bottom but may be placed at a position of any water depth. The hydrogen storage chamber 210 may not be placed in the sea but may be placed in any other water environment, such as a lake or a pond.

### C4. Another Embodiment 4

In the respective embodiments, hydrogen gas is filled into the hydrogen container 110 on the land. The present disclosure is, however, not limited to this configuration. For example, hydrogen gas may be filled into the hydrogen container 110 on the ship 500. In another example, hydrogen gas may be filled in the hydrogen container 110 during a flight in aircraft such as a helicopter or an airplane, and the hydrogen container 110 may be conveyed to the ship 500. In another example, hydrogen gas may be filled into the hydrogen container 110 in a submarine at a water depth above the water depth D1 and may be conveyed to the ship 500. In this example, the hydrogen container 110 may be transported directly from the submarine to the hydrogen storage chamber 210. The hydrogen storage chamber 110 may be thrown into the sea not necessarily from the ship 500 but from the land or from the air.

### C5. Another Embodiment

The configurations of the hydrogen gas compression systems 10 and 10a of the respective embodiments are only illustrative and may be modified in various ways. For example, in the respective embodiments, both the guide support 120 and the tube 320 or 320a are made of the alloy containing nickel and titanium. The guide support 120 and the tube 320 or 320a may, however, be made of any material, such as any other metal material, a resin material or a ceramic material. The hydrogen recovery device 330 may be provided with a compressor. This modified configuration enables hydrogen gas compressed by the hydraulic pressure when the hydrogen storage chamber 210 is placed at a position shallower than the water depth of 7000 m to be further compressed to 70.9 MPa by the compressor. This modified configuration can still omit part of a plurality of compressors provided to compress hydrogen gas in multiple steps, compared with a configuration that compresses hydrogen gas that is not compressed by the hydraulic pressure at all. This configuration also has an advantageous effect of saving electric power required for compression. In the respective embodiments, the process P120 may be omitted. More specifically, the recovery process may be excluded from the hydrogen gas compression process and may be performed as a separate process. In the respective embodiments, the hydrogen recovery device 330 may be provided with a pump configured to feed the hydrogen gas stored in the hydrogen gas storage portion 212 through the tube 320 or 320a to the hydrogen processor 334.

The present disclosure is not limited to any of the embodiments described above but may be implemented by a diversity of other configurations without departing from the scope of the disclosure. For example, the technical features of any of the above embodiments corresponding to the technical features of each of the aspects described in Summary may be replaced or combined appropriately, in order to solve part or all of the problems described above or in order to achieve part or all of the advantageous effects described above. Any of the technical features may be omitted appropriately unless the technical feature is described as essential herein. For example, the present disclosure may be implemented by aspects described below.

(1) According to one aspect of the present disclosure, there is provided a hydrogen gas compression system. This hydrogen gas compression system comprises a hydrogen storage chamber placed at a predetermined water depth in water to communicate with surrounding water; a hydrogen container filled with hydrogen gas by a lower pressure than a hydraulic pressure at the predetermined water depth; a transporting portion configured to guide the hydrogen container that is filled with the hydrogen gas, from above the predetermined water depth to the hydrogen storage chamber; a gas release portion configured to cause the hydrogen gas to be released from the hydrogen container transported to the hydrogen storage chamber and to be stored in the hydrogen storage chamber; a hydrogen recovery device placed above the predetermined depth; and a tube arranged to connect inside of the hydrogen storage chamber with the hydrogen recovery device.

In the hydrogen gas compression system of this aspect, the hydrogen container that is filled with hydrogen gas by the pressure lower than the hydraulic pressure at the predetermined water depth is transported to the hydrogen storage chamber. The hydrogen container is compressed by the hydraulic pressure in the course of the transportation, so that the hydrogen gas filled into the hydrogen container is compressed. The hydrogen storage chamber is arranged to communicate with the surrounding water. This configuration enables the compressed hydrogen gas released from the hydrogen container by the gas release portion to be stored in the compressed state into the hydrogen storage chamber. This configuration does not require a large-scale equipment that withstands the pressure of hydrogen gas and thereby reduces the storage cost of hydrogen gas. As described above, the hydrogen gas compression system of this aspect does not require a compressor or a storage equipment that withstands the high pressure for compression and storage of hydrogen gas and thereby reduces the cost required for compression and storage of hydrogen gas.

(2) In the hydrogen gas compression system of the above aspect, the hydrogen container may be made of a resin. The hydrogen gas compression system of this aspect improves the corrosion resistance of the hydrogen container. In a configuration that the hydrogen storage chamber is placed in the sea, this improves the durability of the hydrogen container.

(3) In the hydrogen gas compression system of the above aspect, the tube may serve as the transporting portion. The hydrogen container may include a main body portion including a hydrogen gas containing portion filled with hydrogen gas; and a ring-shaped mounting portion connected with the main body portion to surround the tube in a circumferential direction. The hydrogen gas compression system of this aspect causes the hydrogen container to be guided by the tube and to sink. This configuration reduces the manufacturing cost of the hydrogen gas compression system, compared with a configuration that is provided with a separate member to guide the hydrogen container in a sinking direction.

The present disclosure may be implemented by various aspects, for example, a hydrogen gas storage system, a hydrogen gas compression method or a hydrogen gas storage method.

What is claimed is:

1. A hydrogen gas compression system, comprising:
a hydrogen storage chamber placed at a predetermined water depth in water to communicate with surrounding water;
a hydrogen container filled with hydrogen gas by a lower pressure than a hydraulic pressure at the predetermined water depth;
a transporting portion configured to guide the hydrogen container that is filled with the hydrogen gas, from above the predetermined water depth to the hydrogen storage chamber;
a gas release portion configured to cause the hydrogen gas to be released from the hydrogen container transported to the hydrogen storage chamber and to be stored in the hydrogen storage chamber;
a hydrogen recovery device placed above the predetermined depth; and
a tube arranged to connect inside of the hydrogen storage chamber with the hydrogen recovery device.

2. The hydrogen gas compression system according to claim 1, wherein the hydrogen container is made of a resin.

3. The hydrogen gas compression system according to claim 1,
wherein the tube serves as the transporting portion, and
the hydrogen container includes:
a main body portion including a hydrogen gas containing portion filled with hydrogen gas; and
a ring-shaped mounting portion connected with the main body portion to surround the tube in a circumferential direction.

4. The hydrogen gas compression system according to claim 2,
wherein the tube serves as the transporting portion, and
the hydrogen container includes:
a main body portion including a hydrogen gas containing portion filled with hydrogen gas; and
a ring-shaped mounting portion connected with the main body portion to surround the tube in a circumferential direction.

5. A hydrogen gas compression method, comprising:
providing a hydrogen container that is filled with hydrogen gas by a lower pressure than a hydraulic pressure at a predetermined water depth;
transporting the hydrogen container filled with the hydrogen gas to a hydrogen storage chamber that is placed at the predetermined water depth in water to communicate with surrounding water;
causing the hydrogen gas to be released from the hydrogen container transported to the hydrogen storage chamber and to be stored in the hydrogen storage chamber; and
feeding the hydrogen gas stored in the hydrogen storage chamber to a hydrogen recovery device that is placed above the predetermined depth, through a tube that is arranged to connect the hydrogen recovery device with the hydrogen storage chamber.
